(19) United States
(12) Patent Application Publication
(10) Pub. No.: US 2024/0123804 A1
(43) Pub. Date: Apr. 18, 2024

(54) VEHICLE SNOW REMOVAL SYSTEM AND METHOD

(71) Applicant: Donovan Silas, Riverside, CA (US)

(72) Inventor: Donovan Silas, Riverside, CA (US)

(21) Appl. No.: 17/965,042

(22) Filed: Oct. 13, 2022

(51) Int. Cl. B60J 11/08

(52) U.S. Cl. CPC B60J 11/08

(57) ABSTRACT

A vehicle snow removal system for preventing snow and ice from accumulating upon a windshield includes a vehicle having a windshield and a cover being removably secured to the windshield of the vehicle to prevent snow and ice from accumulating upon the windshield.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle snow removal systems and more particularly pertains to a new vehicle snow removal system for preventing snow and ice from accumulating upon a windshield.

### (2) Description of Related Art Including Information Disclosed Under 37 CFR 1.97 and 1.98

The prior art relates to vehicle snow removal systems including a variety of systems comprising a cover being placed upon a vehicle. Known prior art lacks a cover being removably secured to a windshield of the vehicle to prevent snow and ice from accumulating upon the windshield.

### BRIEF SUMMARY OF THE INVENTION

An embodiment of the disclosure meets the needs presented above by generally comprising a vehicle having a windshield and a cover being removably secured to the windshield of the vehicle to prevent snow and ice from accumulating upon the windshield.

Another embodiment of the disclosure comprises a method of placing a cover upon a windshield of a vehicle. The cover has a plurality of couplers to secure the cover to the windshield. The cover is removed from the windshield after accumulating snow and ice upon the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle snow removal system according to an embodiment of the disclosure.

FIG. 2 is a side view of an embodiment of the disclosure.

FIG. 3 is a bottom view of an embodiment of the disclosure.

FIG. 4 is a top view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

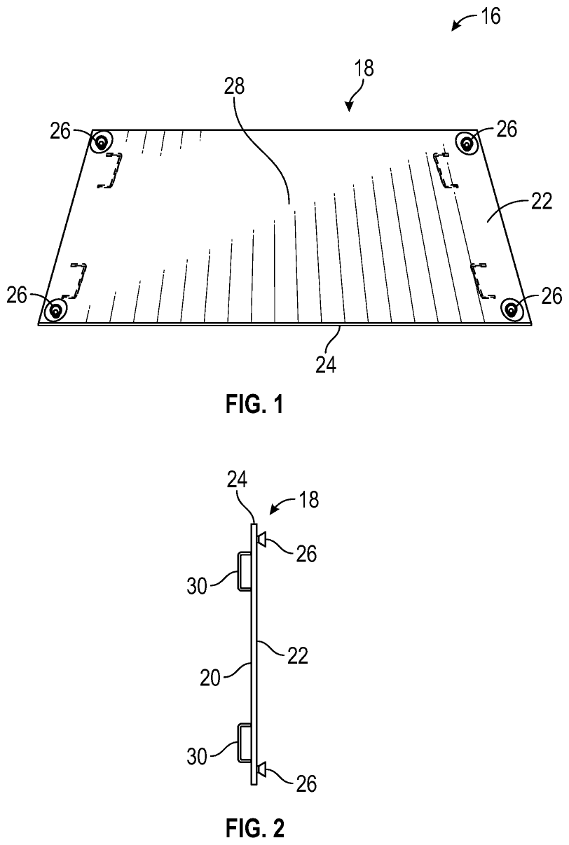

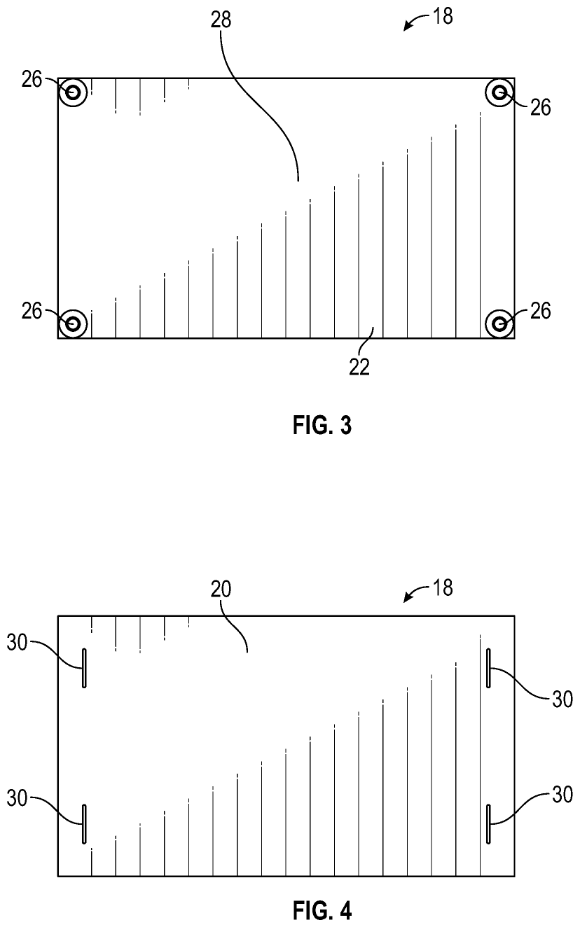

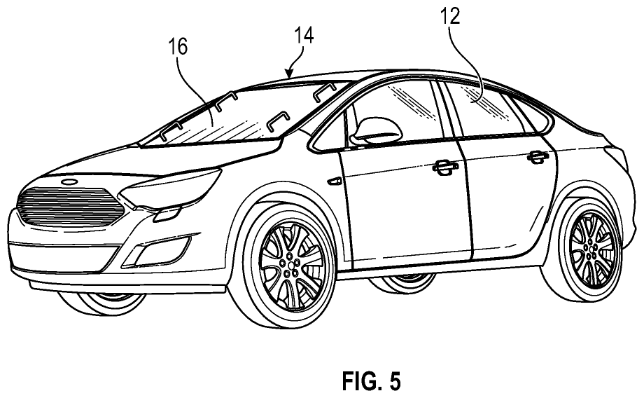

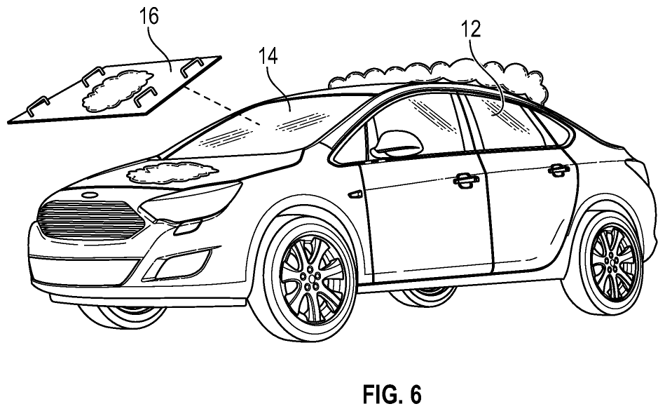

With reference now to the drawings, and in particular to FIGS. 1 through 6 thereof, a new vehicle snow removal system embodying the principles and concepts of an embodiment of the disclosure and generally designated by the reference numeral 10 will be described.

As best illustrated in FIGS. 1 through 6, the vehicle snow removal system 10 generally comprises a vehicle 12 having a windshield 14 and a cover 16 being removably secured to the windshield 14 of the vehicle 12 to prevent snow and ice from accumulating upon the windshield 14. The cover 16 includes a panel 18 having a front side 20, a back side 22, and a perimeter edge 24 being sized to cover an entirety of the windshield 14 to prevent any snow or ice from accumulating between the cover 16 and the windshield 14. The panel 18 will typically have a rectangular shape being complementary to a conventional windshield of vehicles. The panel 18 may comprise a silicone material being lightweight and semi-rigid to conform to an arcuate shape that the windshield 14 may have. The silicone material will typically be liquid impermeable to repel snow and ice from the cover 16 and keep the windshield 14 dry.

A plurality of couplers 26 is mounted on the back side 22 of the panel 18 and is configured for removably securing the panel 18 to the windshield 14. Each of the couplers 26 is positioned proximate to the perimeter edge 24 of the panel 18 and each of the couplers 26 may comprise a suction cup typically being releasably fastenable to windshields. The plurality of couplers 26 may comprise four suction cups being equally spaced from a center 28 of the panel 18 to facilitate in uniformly securing the cover 16 upon the windshield 14.

At least one handle 30 is mounted on the front side 20 of the panel 18 to facilitate in removal of the panel 18 from the windshield 14. The front side 20 of the panel 18 may comprise four handles being positioned on the panel 18 opposite to each one of the couplers 26 to facilitate in removing each of the couplers 26 from the windshield 14.

In use, the cover 16 is placed upon the windshield 14 of the vehicle 12 and secured to the windshield 14 using the plurality of couplers 26. The cover 16 is removed from the windshield 14 after accumulating snow and ice upon the cover 16 such that the windshield 14 is free of snow and ice. The cover 16 may be stored in the vehicle 12 until further use is needed. The lightweight properties of the panel 18 facilitate in carrying the cover 16 by a range of lifting abilities of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle snow removal system comprising:
a vehicle having a windshield; and
a cover being removably secured to said windshield of said vehicle to prevent snow and ice from accumulating upon said windshield.

2. The vehicle snow removal system of claim 1, wherein said cover includes a panel having a front side, a back side, and a perimeter edge.

3. The vehicle snow removal system of claim 1, wherein said perimeter edge is sized to cover an entirety of said windshield.

4. The vehicle snow removal system of claim 1, wherein said panel has a rectangular shape.

5. The vehicle snow removal system of claim 1, wherein said panel comprises a silicone material being semi-rigid and liquid impermeable.

6. The vehicle snow removal system of claim 1, further including a plurality of couplers being mounted on said back side of said panel and being configured for removably securing said panel to said windshield.

7. The vehicle snow removal system of claim 1, wherein each of said couplers is positioned proximate to said perimeter edge.

8. The vehicle snow removal system of claim 1, wherein each of said couplers comprises a suction cup.

9. The vehicle snow removal system of claim 1, wherein said plurality of couplers comprises four suction cups and is equally spaced from a center of said panel.

10. The vehicle snow removal system of claim 1, further including at least one handle being mounted on said front side of said panel to facilitate in removal of said panel from said windshield.

11. A vehicle snow removal system comprising:
a vehicle having a windshield;
a cover being removably secured to said windshield of said vehicle to prevent snow and ice from accumulating upon said windshield, said cover including:
a panel having a front side, a back side, and a perimeter edge, said perimeter edge being sized to cover an entirety of said windshield, said panel having a rectangular shape, said panel comprising a silicone material being semi-rigid and liquid impermeable;
a plurality of couplers being mounted on said back side of said panel and being configured for removably securing said panel to said windshield, each of said couplers being positioned proximate to said perimeter edge, each of said couplers comprising a suction cup, said plurality of couplers comprising four suction cups and being equally spaced from a center of said panel;
at least one handle being mounted on said front side of said panel to facilitate in removal of said panel from said windshield.

12. A method for removing snow from a vehicle comprising the steps of:
placing a cover upon a windshield of a vehicle, said cover having a plurality of couplers to secure said cover to said windshield; and
removing said cover from said windshield after accumulating snow and ice upon said cover.
